(19) United States
(12) Patent Application Publication
(10) Pub. No.: US 2019/0043000 A1
(43) Pub. Date: Feb. 7, 2019

(54) SYSTEM FOR PAIRING UAV AND TRUCK TO MAKE UAV COMPLETE GOODS DELIVEY AND METHOD THEREOF

(71) Applicant: MOXA INC., New Taipei City (TW)

(72) Inventors: Kung-Tso WANG, New Taipei City (TW); Po-Yu CHUANG, New Taipei City (TW); Shao-Hua LI, New Taipei City (TW)

(21) Appl. No.: 15/665,426

(22) Filed: Aug. 1, 2017

(51) Int. Cl. G06Q 10/08; B64C 39/02; B60L 11/18; B64D 45/08; B64D 47/08

(52) U.S. Cl. CPC G06Q 10/083; B64C 39/024; B60L 11/1824; B64C 2201/127; B64D 47/08; B64C 2201/128; B64C 2201/208; B64D 45/08

(57) ABSTRACT

The present disclosure illustrates a system for pairing an unmanned aerial vehicle (UAV) and a truck to make the UAV complete goods delivery and a method thereof. In the system, a control server updates truck status data according to truck messages sent from in-vehicle servers set in different trucks, pairs a UAV and one of the trucks according to the truck status data and a UAV message and generates a task message after the control server receives the UAV message, transmits the task message to the UAV and the paired truck. The UAV carries out a task assigned by the task message after the UAV meets the paired truck according to the task message. The system and the method does not need to set up UAV charging stations, and can achieve the effect of improving delivery efficiency.

### BACKGROUND

### 1. Technical Field

The present disclosure relates to a system of using an unmanned aerial vehicle (UAV) to deliver goods and a method thereof, more particularly to a system of pairing UAV and truck to make the UAV complete goods delivery, and a method thereof.

### 2. Description of Related Arts

With popularization of network shopping, demand for delivering goods by logistic company becomes higher. In conventional logistic industry, goods delivery is performed by using manpower; for example, a freight driver drives a truck or motorcycle, which loads goods, to many delivery locations to deliver the goods to receivers, respectively. When the truck turns into general road from highway, the truck is usually affected by local traffic to reduce delivery efficiency, and it also makes estimation of delivery time difficult. Furthermore, under a condition that the goods delivery locations are distributed, the truck may spend more traffic time to deliver goods, and it also results in a problem of low delivery efficiency.

In order to solve the problem of low delivery efficiency, there are logistic companies using an unmanned aerial vehicle (UAV) to deliver goods to distributed locations and using truck to deliver goods only for areas with intensive locations. However, even if the truck only delivers goods in the areas with intensive locations, the truck may still travel on general road to be affected by local traffic; in addition, currently UAVs fly to deliver goods from warehouse of logistic company, and then fly back to warehouse after delivering goods to the delivery location, as a result, the logistics company must set up a lot of charging stations for UAVs, and it increases logistic cost.

Therefore, what is need is to develop a new system of using an UAV to deliver goods, to solve the conventional technology problem that using the UAV to deliver goods must spend a lot of resources to set up charging stations.

### SUMMARY

In order to solve the conventional technology problem that using the UAV to deliver goods must spend a lot of resources to set up charging stations, the present disclosure is to provide a system for pairing UAV and truck to make the UAV complete goods delivery, and a method thereof.

According to an embodiment, the present disclosure provides a system of pairing UAV and truck to make the UAV complete goods delivery, and the system includes a plurality of in-vehicle servers, a UAV, and a control server. The plurality of in-vehicle servers are respectively disposed in a plurality of trucks and configured to generate truck messages. The UAV is configured to generate a UAV message. The control server is configured to receive the truck messages, and maintain truck status data according to the truck messages, receive the UAV message and pair the UAV with one of the plurality of trucks according to the UAV message and the truck status data. The control server generates and transmits a task message to the UAV and one of the plurality of trucks paired with the UAV, thereby making the UAV meet the paired truck according to the task message to execute a task assigned by the task message.

According to an embodiment, the present disclosure provides a method of pairing UAV and truck to make the UAV complete goods delivery, and the method includes following steps: providing a plurality of in-vehicle servers and a UAV; continuously transmitting, by the plurality of in-vehicle servers respectively mounted in a plurality of trucks, truck messages to a control server; updating truck status data, by the control server, according to the truck messages; transmitting, by the UAV, a UAV message to the control server; pairing, by the control server, the UAV and one of the plurality of trucks according to the UAV message and the truck status data, and generating a task message; transmitting, by the control server, the task message to the UAV and the truck paired with the UAV; and according to the task message, flying the UAV to meet with the truck paired with the UAV, and carry out a task assigned by the task message.

According to above-mentioned content, the difference between the present disclosure and the conventional technology is that the system and method of the present disclosure use the control server to update the truck status data according to the truck messages transmitted from the in-vehicle servers, and after the control server receives the UAV message transmitted from the UAV, the control server pairs the UAV and one of the trucks according to the UAV message and the truck status data and then generates and transmits the task message to the UAV and the truck paired with the UAV, so that the UAV can meet with the truck paired therewith according to the task message, and execute the task assigned by the task message.

As a result, the conventional technology can be solved, and the technical effect of improving shipping efficiency can be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a framework diagram of a system for pairing UAV and truck to make the UAV complete goods delivery, in accordance with the present disclosure.

FIG. 2A is a flowchart showing the steps in an operation of a method for pairing UAV and truck to make the UAV complete goods delivery, in accordance with the present disclosure.

FIG. 2B is a flowchart showing the additional steps in an operation of the method for pairing UAV and truck to make the UAV complete goods delivery, in accordance with the present disclosure.

FIG. 2C is a flowchart showing the steps in an operation of using the UAV to determine a traffic condition for noticing the truck, in accordance with the present disclosure.

### DETAILED DESCRIPTION

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

In the present disclosure, a UAV is transported by a truck to a takeoff location on a main road, and the UAV then, according to a task message transmitted from a control server, deliveries goods to a task destination or flies to the task destination to receive the goods, and the UAV may fly to the same or different truck according to a new task message transmitted from the control server.

The task message of the present disclosure makes the UAV to carry out a task assigned thereto, and may include a task type, identification data of the truck paired with the UAV, takeoff location data, landing location data, destination data, a waiting time, an amount of charging power, or transaction data; however, the present disclosure is not limited to above-mentioned examples. The identification data of the truck can be formed by any arrangement of text, letter, number or symbol, and each piece of identification data may correspond to a truck. The takeoff location data, the landing location data, or the destination data can be the data provided by a positioning system, such as longitude and latitude coordinates provided by a GPS positioning system, but the present disclosure is not limited thereto, and the data defining a specific place can be used in the present disclosure. Transaction data can include data of a receiver or a shipper, but the present disclosure is not limited thereto. In addition, the task type can include the task of receiving goods, the task to deliver goods, the task to wait, or the task to be charged, but the present disclosure is not limited thereto.

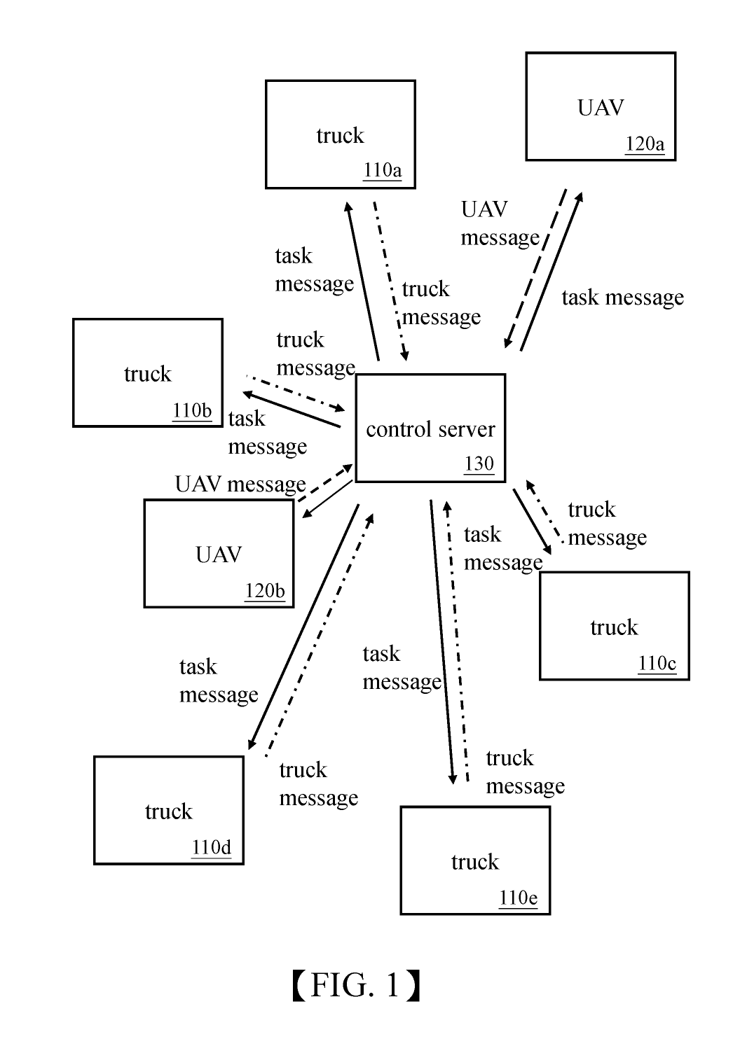

The following refers to FIG. 1, which is a framework diagram of a system for pairing UAV and truck to make the UAV complete goods delivery, for illustration of system operation of the present disclosure. As shown in FIG. 1, the system of the present disclosure includes trucks 110a, 110b . . . and 110e, unmanned aerial vehicles (UAV) 120a and 120b, and a control server 130.

Each of the trucks 110a, 110b . . . and 110e is provided with an in-vehicle server (not shown in figures) configured to generate a truck message. In general, the in-vehicle server can generate a new truck message periodically while the truck is traveling on the way. The truck message generated by the in-vehicle server may include, but the present disclosure is not limited to, vehicle identification data, current location data, current task data, location data of a task destination, planned travel route of the truck, a traffic condition of a road where the truck is travelling, identification data of a UAV paired with the truck, estimated remaining gas amount of the truck, estimated available battery capacity of the truck to charge the UAV, or a UAV parking status of a UAV parking area of the truck. The identification data of the UAV can be formed by arrangement of text, letter, number or symbol, and each piece of identification data corresponds to a UAV. The in-vehicle server may acquire the location data of the truck from an existing positioning system, and the location data may be longitude and latitude coordinates provided by a GPS positioning system; however, the present disclosure is not limited to above examples, and any data defining a specific location may be used in the system and method of the present disclosure.

The in-vehicle server on the truck is electrically linked to and in communication with the control server 130. For example, the in-vehicle server can transmit the generated truck message to the control server 130, and can also receive a task message transmitted from the control server 130. In general, the in-vehicle server may be electrically linked to the control server 130 by mobile communication technology (such as WiMax or LTE) or wireless local area network technology (such as WiFi or Zigbee); however the present disclosure is not limited to these examples.

The in-vehicle server can direct the truck, according to destination data of the task message received from the control server 130, to travel to a task destination corresponding to the destination data, so that the truck can meet with the UAV at the task destination.

The in-vehicle server can receive a notice message transmitted from the control server 130, and according to the traffic condition data of the received notice message, the in-vehicle server can determine whether the truck changes the current travel route.

The UAV can generate a UAV message. In general, the UAV may include an in-UAV server which is configured to generate the UAV message after the UAV is activated or completes the task; however, the present disclosure is not limited to these examples. The UAV message generated by the UAV may include identification data of the UAV, current task data, location data of task destination, identification data of the truck paired with the UAV, current location data provided by the existing positioning system, a planned flight route to task destination, a traffic condition under current flight airspace, an estimated remaining battery capacity, or an estimated remaining flight time.

The UAV can be electrically linked with and in communication to the control server 130. For example, the UAV can transmit the generated UAV message to the control server 130, and receive the task message transmitted from the control server 130. In general, the UAV can be electrically linked to the control server 130 by mobile communication technology (such as WiMax or LTE) or wireless local area network technology (such as WiFi or Zigbee); however, the present disclosure is not limited to these examples.

According to the destination data of the task message received from the control server 130, the UAV can fly to a landing location corresponding to the destination data or the task destination corresponding to the destination data. If task content contained in the task message includes the identification data of the truck, the UAV can fly to the landing location according to the landing location data to meet the truck paired thereto, and then land on the UAV parking area of the truck. In some embodiments, while the UAV approaches the landing location, the UAV can communicate with the truck by communication technology (such as WiFi, Zigbee or Bluetooth), and meanwhile, the UAV can use camera mounted thereon and image recognition technology to determine a landing location on the truck, so that the UAV may land on the landing location of the moving truck; however, the manner that the UAV lands on the truck is not limited to above-mentioned example.

The UAV can carry out the task according to the received task message. For example, when the task contained the task message is to be charged, the UAV can meet the paired truck according to the landing location data, and then land on the paired truck to be charged. In an embodiment, the UAV may be charged at least by the charging time recorded in the task message. When the task contained the task message is to unload goods, the UAV can meet with the paired truck according to the landing location data, and then park on the paired truck to wait for the goods delivery device (not shown in figures), which is disposed on the truck, to unload the goods of the shipper from the UAV. When the task is to deliver goods, the UAV can meet the paired truck according to the landing location data and park on the truck, and the UAV then waits for receiving the goods, which is to be delivered to a receiver, from the goods delivery device disposed on the truck. After the goods to be delivered is placed into a goods box of the UAV, the UAV can take off when determining that the truck travels to the takeoff location contained in the takeoff location data, to deliver the goods to the task destination corresponding to the destination data. After the UAV reaches the task destination, the UAV can execute a sign procedure for acceptance of the goods. When the task is to receive goods, the UAV can fly to the task destination corresponding to the landing location data, and execute receiving procedure for receiving goods according to the transaction data.

Furthermore, the goods delivery device of the present disclosure can include a pneumatic unit which is vertically or horizontally movable, so that the goods delivery device can use the pneumatic unit to push goods from the goods container to a fixed position under the UAV, or push goods located under the UAV into the goods container.

While the UAV is moving to the task destination, the UAV can determine moving speeds of vehicles traveling on road sections under the current flight airspace thereof, and transmit the determined moving speeds of the vehicles to the control server 130. For example, the UAV can use the camera thereof (not shown in figures) to shoot at least one vehicle, and further use conventional optical flow method to calculate relative speed(s) (ΔV) of at least one shot vehicle relative to the UAV, and the moving speed of the vehicle shot by the camera is a sum (ΔV+V) of the relative speed (ΔV) between the shot vehicle and the UAV and a moving speed (V) of the UAV.

The control server 130 is configured to continuously receive the truck messages transmitted from in-vehicle servers disposed on the trucks 110a, . . . and 110e, and continuously receive the UAV messages transmitted from the UAVs 120a and 120b.

The control server 130 is also configured to create and maintain truck status data, and update the maintained truck status data according to the received truck messages; that is, the control server 130 updates a portion of the truck status data associated with the truck just transmitting the truck message. In general, items of the truck status data may include all or a part of items of the truck message; in other words, the truck status data may include identification data, current location data, current task data, location data of task destination, or a travel route, identification data of the paired UAV, a remaining gas amount, the available battery capacity to charge the UAV, the UA parking status of the UAV parking area of each of the trucks. The parking status of the UAV may include a maximum number of total UAVs allowable to park on the truck and a number of the UAVs currently parking on the truck; furthermore, the parking status of the UAV may record a remaining number of the UAVs allowable to park on the truck.

The control server 130 can continuously receive the UAV messages transmitted from the UAVs 120a and 120b; and according to the received UAV messages and the maintained truck status data, the control server 130 can pair one of the trucks and the UAV which currently transmits the UAV message. Each UAV is paired with only one truck at the same time; on the other hand, if there is still sufficient space in the UAV parking area of the truck, the truck is able to pair with one or more UAV(s).

In general, when the control server 130 receives the UAV message transmitted from the UAV, the control server 130 can pair one of the trucks with the UAV transmitting the UAV message, according to the UAV location data of the UAV message and the maintained truck status data. For example, according to the UAV location data of the UAV message and the truck location data of each truck recorded in the truck status data, the control server 130 can respectively calculate a distance between the UAV 120a, which transmits the UAV message, and each of the trucks 110a, . . . and 110e; next, according to the calculated distances between the UAV 120a and each of the trucks 110a, . . . and 110e, from near to far, the control server 130 checks whether the UAV parking status of the truck status data corresponding to one of the trucks indicates that the truck has a sufficient area to park the UAV. For example, the control server 130 may check the trucks in a sequential order of the truck 110a, the truck 110b, the truck 110c, the truck 110e and the truck 110d, if the UAV parking status of the truck 110a indicates that the truck 110a is able to park the UAV, the control server 130 pairs the truck 110a with the UAV 120a, and updates the UAV parking status of the truck 110a in the maintained truck status data, for example, the number of the UAV parking on the truck 110a is added by one. If the UAV parking status of the truck 110a indicates that the truck 110a is unable to park the UAV, the control server 130 can continuously check the UAV parking status of next truck 110b, according to the distances between the UAV and truck recorded the truck status data, and so forth.

The control server 130 can also generate a task message according to the pairing result between the UAV and the truck, and transmit the generated task message to the UAV, which transmits the UAV message, and the truck paired with this UAV, so that the UAV and the truck paired therewith can move (fly or drive) to the landing location corresponding to the landing location data, according to the landing location data recorded in the task message.

After the control server 130 receives a new truck message transmitted from the truck paired with the UAV and updates the truck status data according to the new truck message, the control server 130 can determine whether the truck may early reach or delay to the landing location, according to the updated truck status data; if not, the control server 130 does not perform any extra process; if yes, the control server 130 can generate new task message including the new landing location data, according to the updated truck status information, and transmit the generated new task message to the UAV, so that the UAV can meet the paired truck at the new landing location according to the new task message.

The control server 130 can create and maintain UAV status data. The control server 130 can update the maintained UAV status data according to the received UAV message, that is, the status of the UAV currently transmitting the UAV message is updated in the UAV status data. In general, the items contained the UAV status data can include all or a part of the items contained in the UAV message, that is, the UAV status data can include identification data, current task data, location data of task destination, identification data of the paired truck, current location data provided by the existing positioning system, a planned flight route to task destination, an estimated remaining battery capacity, and an estimated remaining flight time of each UAV.

The control server 130 can receive a request for shipping application from an external system (such as a freight website), and select one of the UAVs to correspond to the shipping application, according to the status data of the UAVs and the received shipping application, and then generate and transmit a task message, which indicates a task of receiving goods, to the selected UAV, so that the selected UAV, according to the received task message, can fly to the task destination corresponding to the destination data to execute task of receiving goods. The control server 130 can generate destination data corresponding to a shipping address contained in the received shipping application, and determine distances between each of the UAVs and the task destination (that is, the shipping address) according to the generated destination data, and the location data of the task destinations or current location data of the UAVs; next, the control server 130 can select one of the UAVs according to the remaining battery capacities or remaining flight times of the UAVs and the distances between each of the UAVs and the generate destination data. Preferably, the selected UAV has the remaining battery capacity or remaining flight time sufficient to reach the task destination and is nearest to the task destination. However, the manner that the control server 130 of the present disclosure selects the UAV to correspond to the shipping application is not limited to above-mentioned example.

The control server 130 can receive moving speeds of vehicles, which travels on one or more road sections, transmitted from the UAVs. When the control server 130 determines the receive moving speed is lower than a threshold value, the control server 130 generates a notice message corresponding to the road section where vehicle moving with a speed lower than the threshold value, and transmits the generated notice message to in-vehicle servers of all or a part of the trucks, so that the in-vehicle servers receiving the notice message can determine whether the truck should be guided to not travel to the road section where the vehicle currently moving with speed lower the threshold value.

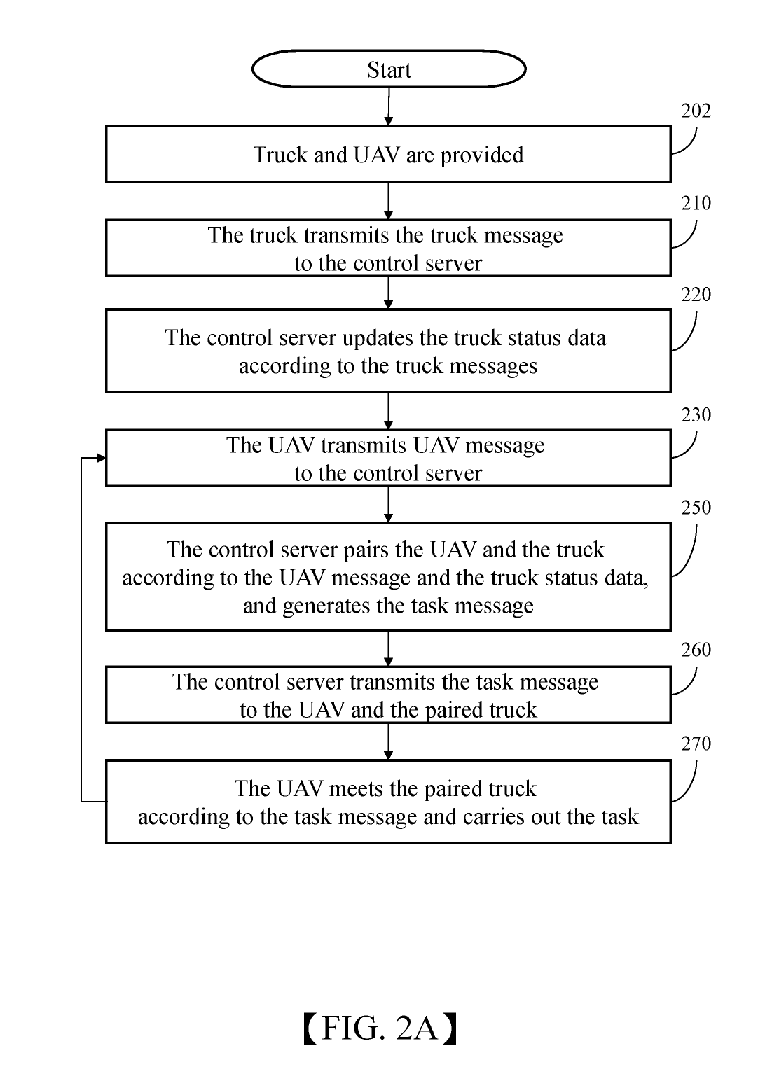

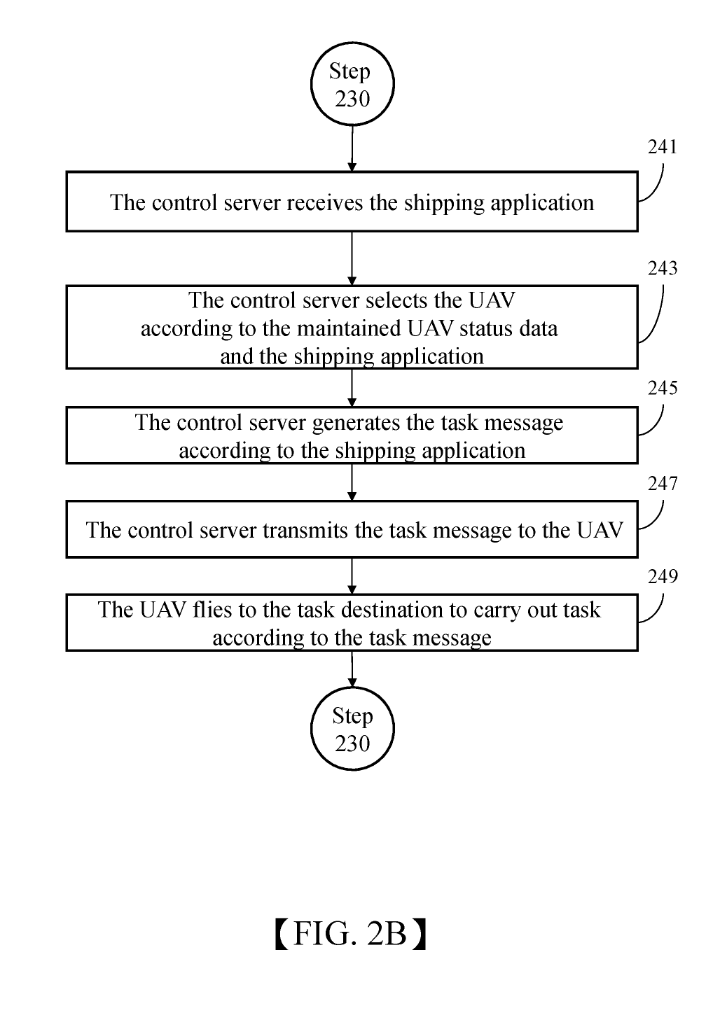

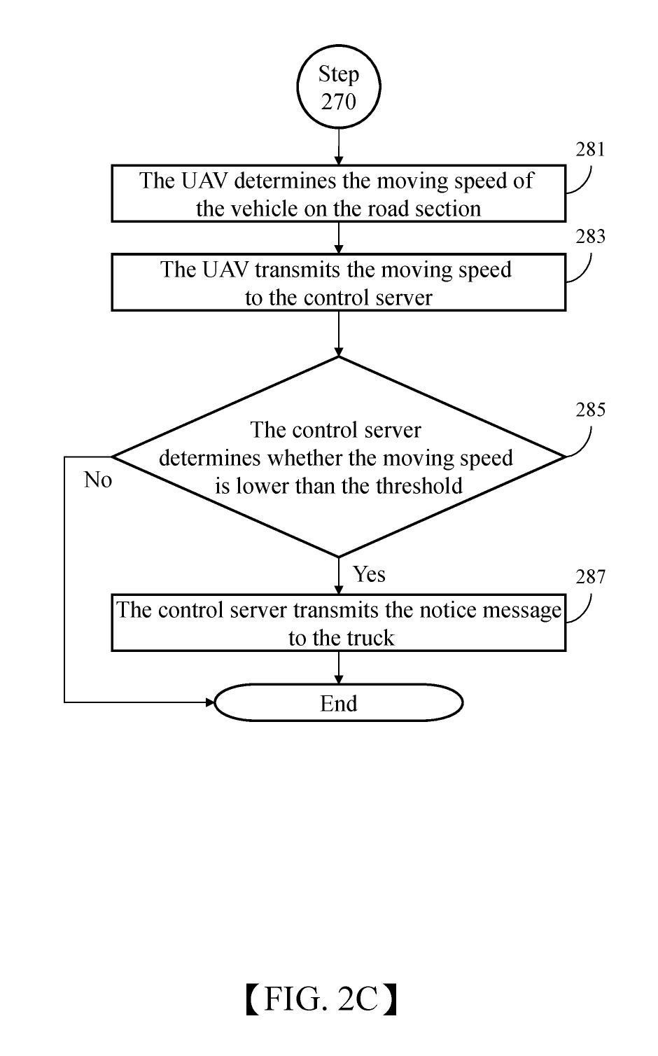

The following describe an embodiment to illustrate operations of the system and method of the present disclosure. Please refer to FIG. 2A, which is a flowchart showing the steps in an operation of a method of pairing the UAV and the truck to make the UAV complete goods delivery.

First of all, in a step 202, an UAV, and a truck disposed with an in-vehicle server, are provided. In this embodiment, a logistics company using technology of the present disclosure owns multiple trucks 110a, 110b, . . . and 110e, and multiple UAVs 120a and 120b, and each of the trucks 110a, 110b, . . . and 110e can have at least one UAV parking area located at a roof of the truck or a top surface of a container according to a size of the truck or a size of the container of the truck. The control server 130 can be operated to distribute goods to be delivered by the trucks 110a, 110b . . . and 110e.

After the trucks 110a, 110b . . . and 110e start, in a step 210, the in-vehicle servers on the trucks 110a, 110b . . . and 110e can transmit truck messages to the control server 130 before the trucks travel. In a step 220, after the control server 130 receives the truck messages transmitted from the in-vehicle servers on the trucks 110a, 110b . . . and 110e, the control server 130 can update the truck status data according to the received truck messages.

Furthermore, in a step 230, after being started, the UAVs 120a and 120b can transmit the UAV messages to the control server 130. In a step 250, after the control server 130 receives the UAV messages transmitted from the UAVs 120a and 120b, the control server 130 can pair the UAVs and the trucks according to the received UAV messages and the truck status data, and generate the task messages. In this embodiment, initially, the UAVs 120a and 120b and the trucks 110a, 110b, . . . 110e stay in the logistics company, that is, the distances between the UAVs 120a and 120b, and the trucks 110a, 110b, . . . and 110e are zero, so the control server 130 can pair the UAV 120a and 120b, and the trucks 110a, 110b, . . . and 110e, and generate the task messages according to the UAV parking statuses of the trucks recorded in the truck status data, and a number of distribution orders recording the goods to be delivered by the UAVs. The UAVs 120a and 120b can fly to the paired truck for goods delivery according to the task messages.

In a step 260, after the control server 130 generates the task messages for each of the UAVs 120a and 120b, the control server 130 respectively transmits the generated task messages to the UAVs 120a and 120b and the trucks paired with the UAVs 120a and 120b. In a step 270, after the UAVs 120a and 120b receive the task messages transmitted from the control server 130, each of the UAVs 120a and 120b moves to the task destination according to the task messages, to meet the paired truck and carry out the task assigned by the received task message. In this embodiment, suppose that the UAV 120a is paired with the truck 110b and the UAV 120b is paired with the truck 110e, the UAV 120a can respectively fly to and park on the paired truck 110b, and the goods delivery device of the trucks 110b then pushes out goods from a container to a location under the UAV 120a according to the delivery identification data of the to-be-delivered goods contained in the task message. Next, the UAV 120a can clamp the goods, which is pushed by the goods delivery device of the truck 110b to the location under the UAV 120a to be delivered, and then place the clamped goods into the goods box of the UAV 120a. It should be noted that the UAV 120b and the truck 110e paired therewith also perform above operations. The UAV can be in communication with the truck by wireless communication technology (such as WiFi, Zigbee or Bluetooth), and use camera and image recognition technology to determine a suitable location to land on the truck. After the UAV determines the location to land, the UAV lands on the determined location.

In a step 210, after the UAV 120a paired with the truck 110b, and the UAV 120b paired with the truck 110e respectively fly to and park on the truck 110b and the truck 110e, or the in-vehicle servers of the trucks 110a, 110c and 110d confirm that the trucks 110a, 110c and 110d are not paired with UAV, all of the trucks can start to travel, and the in-vehicle servers of all trucks can transmit the truck messages to the control server 130 periodically. In a step 220, the control server 130 can continuously update the truck status data according to the received truck messages. In this embodiment, suppose that each of the trucks travels on highway and main road only, and each of the UAVs reciprocates between the task destination and the truck paired therewith.

When the UAV 120a determines that the truck 110b reaches the takeoff location on the highway or main road corresponding to the takeoff location data of the received task message, the UAV 120a can take off from the traveling truck 110b and fly to the task destination corresponding to the destination data of the task message. After the UAV 120a reaches the task destination, the UAV 120a can carry out a goods delivery operation to ship the goods to the receiver. It should be noted that the UAV 120b and the truck 110e paired therewith can also perform above operations. In this embodiment, the receiver must show pick-up identification data, which the control server 130 provides to the receiver in advance and may be a QR code, in front of the camera of the UAV, so that the UAV can acquire the pick-up identification data, and then determine whether the receiver is correct according to the acquired pick-up identification data and the transaction data of the task message transmitted from the control server 130; if yes, the UAV can open the box door of the goods box and indicate, through an indicator light, the receiver to take the goods placed in the goods box; if not, the UAV can alert and transmit an alert message to the control server 130. When the UAV determines, according to a detecting result of the pressure sensor or image sensor mounted inside the goods box, that the goods is taken out by the receiver, the UAV can close the box door of the goods box, thereby completing the goods delivery task. It is worth noting that the UAV may not take off to fly away until the UAV determines, according to a detecting result of a sensor mounted on a machine body thereof, that the receiver is spaced apart therefrom by a safe distance.

In a step 230, after the UAV 120a completes the goods delivery task according to the task message transmitted from the control server 130, the UAV 120a can transmit the UAV message to the control server 130. In a step 250, after the control server 130 receives the UAV message transmitted from the UAV 120a, the control server 130 can pair the UAV 120a with one of the trucks again according to the received UAV message and continuously-updated truck status data, and generate new task message. In this embodiment, suppose that the control server 130 can filter out the truck, which needs the UAV, according to the UAV parking statuses of the trucks recorded in the truck status data and the quantity of the to-be-delivered goods recorded in the truck status data, for example, the control server 130 finds that the trucks 110a and 110d need UAVs, so that the control server 130 can determine to pair the UAV 120a with the truck 110a or 110d according to truck location data of the trucks 110a and 110d recorded in the truck status data and the UAV location data recorded in the UAV message. If the UAV 120a is nearer to the truck 110d than to the truck 110a, the control server 130 can pair the UAV 120a with the truck 110d and generate the new task message to make the UAV 120a deliver goods again.

In a step 260, after the control server 130 pairs the UAV 120a with the truck 110d and generates the new task message, the control server 130 can transmit the generated task message to the UAV 120a and the truck 110d paired with the UAV 120a. In a step 270, after the UAV 120a receives the task message transmitted from the control server 130, the UAV 120a starts flying, according to the task message, to the landing location on the highway or main road corresponding to the landing location data, so as to meet the paired truck 110d and obtain to-be-delivered goods placed on the truck 110d; next, when the UAV 120a determines that the truck 110d reaches the takeoff location, on highway or main road, corresponding to the takeoff location data, the UAV 120a can take off and deliver the goods to the task destination corresponding to the destination data, thereby completing the goods delivery task assigned by the received task message.

In the step 230, after the UAV 120a completes the goods delivery task again according to the task message transmitted from the control server 130, the UAV 120a can transmit the UAV message to the control server 130 again. In the step 250, after the control server 130 receives the UAV message transmitted from the UAV 120a, the control server 130 can pair the UAV 120a with one of the trucks according to the received UAV message and continuously-updated truck status data, and generate new task message. In this embodiment, if the control server 130 determines, according to the UAV message transmitted from the UAV 120a, that the UAV 120a needs to be charged, for example, the control server 130 determines the remaining battery capacity or remaining flight time recorded in the UAV message transmitted from the UAV 120a to be lower than a predetermined value, or the control server 130 determines that the remaining battery capacity or the remaining flight time recorded in the UAV message is not enough to make the UAV 120a reach a next task destination, the control server 130 can determine the truck to be paired with the UAV 120a according to the UAV parking statuses of the trucks and the truck location data recorded in the truck status data, and the UAV location data recorded in the UAV message. Suppose that the control server 130 can select the truck 110c, which has remaining UAV parking area to park the UAV 120a and is nearest to the UAV 120a, to pair with the UAV 120a, and then generate the task message to make the UAV 120a fly to the paired truck 110c to carry out the charging task.

In a step 260, after the control server 130 pairs the UAV 120a with the truck 110c and generates the task message, the control server 130 can transmit the generated task message to the UAV 120a and the truck 110c paired with the UAV 120a. In a step 270, after the UAV 120a receives the task message transmitted from the control server 130, the UAV 120a can fly to meet, according to the task message, the paired truck 110c at the landing location, on highway or main road, corresponding to the landing location data, and carry out the task assigned by the received task message. In this embodiment, the UAV 120a is parked on the paired truck 110c to be charged until the amount of electrical power stored in the battery of the UAV 120a meets the charging amount contained in the task message, or the time of the UAV 120a being charged meets the charging time contained in the task message.

In a step 230, after the UAV 120a completes the charging task according to the task message transmitted from the control server 130, the UAV 120a can transmit the UAV message to the control server 130. In this embodiment, in a step 241, if the control server 130 receives the shipping application before the control server 130 receives the UAV message transmitted from the UAV 120a, in a step 243, the control server 130 can select one of the UAVs corresponding to the shipping application according to the maintained UAV status data and the received shipping application, as shown in FIG. 2B, and generate the task message indicative of receiving goods according to the shipping application in a step 245, and transmit the generated task message to the UAV 120a sending the UAV message in a step 247.

In a step 249, after the UAV 120a receives the task message transmitted from the control server 130, the UAV 120a can fly to the task destination according to the received task message, to carry out the goods receiving operation, thereby completing the goods-receiving task. In this embodiment, when the UAV 120a reaches the shipping location (that is, the task destination), the shipper must show shipping identification data, which is provided by the control server 130 to the shipper in advance and may be a QR code, in front of the camera of the UAV, so that the UAV can acquire the shipping identification data and determine whether the shipper is correct according to the acquired shipping identification data and the transaction data recorded in the task message transmitted from the control server 130; if yes, the UAV 120a can open the box door of the goods box thereof and indicate the shipper, through the indicator light, to place the goods into the goods box; if not, the UAV 120a can alert and transmit the alert message to the control server 130. After the UAV 120a determines, according to the detecting result of the pressure sensor or image sensor, that the shipper has placed the goods into the goods box, the UAV 120a can close the box door of the goods box, thereby completing the goods-receiving task.

In a step 230, after the UAV 120a completes the goods-receiving task according to the task message transmitted from the control server 130, the UAV 120a can transmit the UAV message to the control server 130. In the step 250, after the control server 130 receives the UAV message transmitted from the UAV 120a, the control server 130 can pair the UAV 120a with one of the trucks again according to the received UAV message and the continuously-updated truck status data, and generate a new task message.

As a result, when the goods-delivery location or goods-receiving location is on a branch road, the truck can just travel on main road or highway, and when the truck approaches the goods-delivery location or goods-receiving location, the UAV parking on the truck can fly to the goods-delivery location or goods-receiving location to complete the goods-delivery task or goods-receiving task.

Furthermore, in above embodiments, in the step 270, when the UAV 120a or the UAV 120b flies to meet the truck paired therewith to execute the task according to the task message, as shown in FIG. 2C, the UAV 120a or the UAV 120b can use the camera to capture traffic images of road sections under the current flight airspace, and in a step 281, determine the moving speeds of vehicles traveling on the road sections in the traffic images, and in a step 283, the UAV 120a or the UAV 120b can transmit the determined moving speed of the vehicle on the road sections to the control server 130.

In a step 285, after the control server 130 receives the moving speeds of the vehicles moving on the road sections, and the control server 130 can determine whether the moving speeds of the vehicles moving on the road section are below the threshold value; if the moving speed is not below the threshold value, the control server 130 does not perform extra process. In a step 287, if the control server 130 determines that the moving speed of the vehicle moving on one or more road section is below the threshold value, the control server 130 can generate the notice message corresponding to the road section where the vehicle moves with speed below the threshold value, and then transmit the notice message to the in-vehicle servers of the trucks, so that the in-vehicle server receiving the notice message can determine whether the truck should be guided to the road section where the vehicle travels with speed below the threshold value, or to other road section.

To summarize, the difference between the present disclosure and the conventional technology is that the system and method of the present disclosure use the control server to update the truck status data according to the truck message transmitted from the trucks, and after the control server receives the UAV message transmitted from the UAV, the control server pairs the UAV and one of the trucks according to the UAV message and the truck status data and then generates and transmits the task message to the UAV and the truck paired with the UAV, so that the UAV can meet with the truck paired therewith according to the task message, and execute the task assigned by the task message. As a result, the conventional technology that using UAV to deliver goods must spent a lot of resources to set up charging stations can be solved, and the technical effect of improving shipping efficiency can be achieved.

Furthermore, the method of pairing the UAV and truck to make the UAV complete goods delivery, in accordance with the present disclosure, can be implemented by hardware, software or a combination thereof, or implemented in a computer system by a centralization manner, or implemented in different devices distributed in multiple interconnected computer systems by a distribution manner.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A method of pairing unmanned aerial vehicle (UAV) and truck to make the UAV complete goods delivery, comprising:
providing a plurality of trucks and a UAV;
continuously transmitting, by in-vehicle servers respectively mounted in the plurality of trucks, truck messages to a control server;
updating truck status data, by the control server, according to the truck messages;
transmitting, by the UAV, a UAV message to the control server;
pairing, by the control server, the UAV and one of the plurality of trucks according to the UAV message and the truck status data, and generating a task message;
transmitting, by the control server, the task message to the UAV and the truck paired with the UAV; and
according to the task message, flying the UAV to meet with the truck paired with the UAV, and carry out a task assigned by the task message.

2. The method according to claim 1, before the step of pairing the UAV and one of the plurality of trucks according to the UAV message and the truck status data, further comprising:
receiving, by the control server, a shipping application, and then selecting the UAV according to the shipping application and UAV status data, which is maintained by the control server; and
generating and transmitting other task message to the UAV, to make the UAV carry out goods-receiving task at other task destination according to the other task message.

3. The method according to claim 1, wherein the step of pairing the UAV and one of the plurality of trucks according to the UAV message and the truck status data further comprises:
pairing, by the control server, the UAV with one of the plurality of trucks according to UAV location data of the UAV message and truck location data and UAV parking status of each of the plurality of trucks recorded in the truck status data.

4. The method according to claim 1, after the step of transmitting the task message to the UAV and the truck paired with the UAV, further comprising:
updating, by the control server, the truck status data according to a new truck message transmitted from the truck paired with the UAV; and
generating a new task message comprising new landing location data according to the truck status data when the control server determines that the paired truck delays to or early reaches the task destination according to the truck status data, and transmitting the new task message to the UAV to make the UAV meet the paired truck at the new landing location according to the new task message, to execute the task.

5. The method according to claim 1, wherein the step of driving the UAV to meet with the paired truck, further comprises:
communicating the UAV and the paired truck by wireless technology; and
using image recognition technology to determine a landing location on the paired truck to land the UAV on the landing location.

6. The method according to claim 1, wherein the task executed by the UAV comprises that the UAV parks on the paired truck to be charged.

7. The method according to claim 1, wherein the task executed by the UAV comprises that the UAV parks on the paired truck to wait for a goods delivery device of the paired truck to unload the goods from the UAV.

8. The method according to claim 1, wherein the task executed by the UAV comprises that the UAV parks on the paired truck to wait for a goods delivery device of the paired truck to place the goods into the UAV, and when the UAV determines the paired truck to reach a takeoff location, the UAV flies to execute goods delivery task.

9. The method according to claim 1, wherein the step of flying the UAV to meet the paired truck at the task destination and execute the task according to the task message, further comprises:
determining, by the UAV, a moving speed of at least one vehicle traveling on a road section, and transmitting the moving speed to the control server; and
transmitting a notice message, by the control server, to the in-vehicle servers of the plurality of trucks when the moving speed is determined to be below a threshold value.

10. A system of pairing UAV and truck to make the UAV complete goods delivery, comprising:
a plurality of in-vehicle servers, respectively disposed in a plurality of trucks and configured to generate truck messages corresponding to the plurality of trucks;
a UAV configured to generate a UAV message; and
a control server configured to receive the truck messages, and maintain truck status data according to the truck messages, receive the UAV message and pair the UAV with one of the plurality of trucks according to the UAV message and the truck status data, wherein the control server generates and transmits a task message to the UAV and one of the plurality of trucks paired with the UAV, thereby making the UAV meet the paired truck according to the task message to execute a task assigned by the task message.

11. The system according to claim 10, wherein the control server is configured to receive a shipping application and maintain UAV status data according to the UAV message, and select the UAV according to the UAV status data and the shipping application, and generate and transmit other task message to the UAV, and the UAV receives the other task message and flies to other task destination to execute goods-receiving task according to the other task message.

12. The system according to claim 10, wherein the control server pairs the UAV with one of the plurality of trucks according to UAV location data of the UAV message and truck location data and UAV parking statuses recorded in the truck messages

13. The system according to claim 10, wherein the control server updates the truck status data according to a new truck message transmitted from the paired truck, and when the control server determines, according to the truck status data, that the paired truck delays to or early reaches the task destination, the control server generates a new task message comprising new landing location data according to the truck status data, and transmits the new task message to the UAV to make the UAV meet the paired truck at the new landing location according to the new task message.

14. The system according to claim 10, wherein the UAV is in communication with the paired truck by wireless technology and uses image recognition technology to determine a landing location on the paired truck, so as to land on the landing location.

15. The system according to claim 10, wherein the task executed by the UAV comprises that the UAV parks on the paired truck to be charged.

16. The system according to claim 10, wherein the task executed by the UAV comprises that the UAV parks on the paired truck and waits for a goods delivery device of the paired truck to unload the goods from the UAV.

17. The system according to claim 10, wherein the task executed by the UAV comprises that the UAV parks on the paired truck and waits for a goods delivery device of the paired truck to place the goods to the UAV, and when the UAV determines the paired truck to reach a takeoff location, the UAV flies to execute goods delivery task.

18. The system according to claim 10, wherein the UAV determines a moving speed of at least one vehicle traveling on a road section, and transmitting the moving speed to the control server, and transmits a notice message, by the control server, to the in-vehicle servers of the plurality of trucks when the moving speed is determined to be below a threshold value.
